(19) United States
(12) Patent Application Publication
(10) Pub. No.: US 2016/0177084 A1
(43) Pub. Date: Jun. 23, 2016

(54) REINFORCING MATERIAL, REINFORCED MATRIX RESIN, FIBER-REINFORCED RESIN COMPOSITE, AND METHOD FOR MANUFACTURING REINFORCING MATERIAL

(71) Applicant: DIC CORPORATION, Itabashi -ku, Tokyo (JP)

(72) Inventors: Kenichi Hamada, Sakura-shi (JP); Takeshi Yamazaki, Sakura-shi (JP)

(21) Appl. No.: 14/910,085

(22) PCT Filed: May 23, 2014
(86) PCT No.: PCT/JP2014/063691

§ 371 Date: Feb. 4, 2016

(30) Foreign Application Priority Data
Aug. 6, 2013 (JP) 2013-163191

(51) Int. Cl. C08L 63/00; C08L 1/02; C08J 5/04

(52) U.S. Cl. CPC C08L 63/00; C08J 5/045; C08L 1/02; C08J 2363/00; C08J 2301/02; C08J 2401/02; C08J 2463/00

(57) ABSTRACT

Provided is a fiber-reinforced resin composite having a higher strength than conventional fiber-reinforced resins. Also provided is a reinforced matrix resin for fiber-reinforced resins that is used to provide a fiber-reinforced resin composite having a higher strength than conventional fiber-reinforced resins. A reinforcing material is manufactured by adding cellulose to an epoxy resin and applying a mechanical shear force to the cellulose to form nanofibers. A reinforcing material containing an epoxy resin and cellulose nanofibers present therein in a fibrillated state is added to another matrix resin, and reinforcing fibers are added to the matrix resin.

### TECHNICAL FIELD

The present invention relates to reinforcing materials suitable for use in fiber-reinforced resins, to reinforced matrix resins and fiber-reinforced resin composites containing such reinforcing materials, and to methods for manufacturing such reinforcing materials.

### BACKGROUND ART

Fiber-reinforced resins are gaining increased attention as lightweight high-performance materials. In particular, fiber-reinforced resins are expected to replace metals in the fields of transportation machines, such as automobiles and aircraft, and electronic components.

Fiber-reinforced resins have low weight and high strength due to the combination of synthetic resins and carbon or glass fibers; however, there is a need for higher strength.

PTL 1 discloses an invention related to the addition of cellulose nanofibers, which are a plant-derived natural nanofiller, to a fiber-reinforced resin. The addition of cellulose nanofibers, which are obtained by fibrillating cellulose, reinforces the fiber-reinforced resin.

To pulverize cellulose, which has numerous hydroxyl groups, into nanofibers, current technology requires fibrillation in water or in a mixture of a resin and a large amount of water; therefore, the resulting cellulose nanofibers contain much water (see PTL 2). To combine these water-containing cellulose nanofibers with various resins, the manufactured cellulose nanofibers need to be subjected to a dehydration process or to a process of replacing moisture with an alcohol and then removing the solvent. Another problem is that the cellulose nanofibers reaggregate during the dehydration process since cellulose readily forms intermolecular hydrogen bonds. The fiber aggregates are poorly dispersible in resins and thus are difficult to combine with resins.

### CITATION LIST

### Patent Literature

PTL 1: Japanese Unexamined Patent Application Publication No. 2010-24413

PTL 2: Japanese Unexamined Patent Application Publication No. 2005-42283

### SUMMARY OF INVENTION

### Technical Problem

In view of the foregoing background, an object of the present invention is to provide a reinforcing material that can be used to manufacture a fiber-reinforced resin having a higher strength than conventional fiber-reinforced resins in a substantially nonaqueous system without using a large amount of water. Another object of the present invention is to provide a reinforced matrix resin and a fiber-reinforced resin composite containing such a reinforcing material and a method for manufacturing such a reinforcing material.

### Solution to Problem

After conducting extensive research, the inventors have discovered that cellulose nanofibers obtained in a substantially nonaqueous system without using water or an organic solvent by directly fibrillating or pulverizing cellulose in an epoxy resin can be used as a reinforcing material to improve the strength of a fiber-reinforced resin composite. The inventors have also discovered that a reinforced matrix resin containing the reinforcing material and a matrix resin can be readily combined with reinforcing fibers and that they can be combined to provide a superior fiber-reinforced resin composite.

Specifically, the present invention provides a reinforcing material containing an epoxy resin and cellulose nanofibers present therein in a fibrillated state.

The present invention further provides a reinforced matrix resin containing the reinforcing material and a matrix resin.

The present invention further provides a fiber-reinforced resin composite containing the reinforced matrix resin, which contains the reinforcing material and the matrix resin, and reinforcing fibers.

The present invention further provides a method for manufacturing a reinforcing material. This method includes adding cellulose to an epoxy resin and applying a mechanical shear force to the cellulose to form nanofibers.

### Advantageous Effects of Invention

According to the present invention, cellulose nanofibers obtained in a substantially nonaqueous system without using water or an organic solvent by directly fibrillating or pulverizing cellulose in an epoxy resin can be used as a reinforcing material to provide a fiber-reinforced resin composite with improved strength. Since the cellulose nanofibers are obtained by directly fibrillating cellulose in an epoxy resin, the cellulose nanofibers in the resulting reinforcing material are not hydrated as in fibrillation in an aqueous solvent and thus have a high affinity for resins. Therefore, a high concentration of cellulose nanofibers can be added to a matrix resin, and a fiber-reinforced resin can be effectively reinforced with the cellulose nanofibers to provide a fiber-reinforced resin composite with improved strength.

### DESCRIPTION OF EMBODIMENTS

Embodiments of the present invention will now be described in detail.

### Reinforcing Material

A reinforcing material according to the present invention contains an epoxy resin and cellulose nanofibers present therein in a fibrillated state and is used to reinforce a fiber-reinforced resin. Since the cellulose nanofibers are obtained in a substantially nonaqueous system by directly fibrillating cellulose in the epoxy resin, they are not hydrated as in fibrillation in an aqueous solvent and thus have a higher affinity for a matrix resin than cellulose nanofibers obtained by fibrillating cellulose in water or an organic solvent. Therefore, a high concentration of cellulose nanofibers can be combined with a matrix resin, and a fiber-reinforced resin can be reinforced with the reinforcing material to provide a fiber-reinforced resin composite with high strength.

Although the term “cellulose nanofibers in a fibrillated state” as used herein is difficult to define precisely, it refers to, for example, cellulose fibers split to a fiber diameter of 5 to 1,000 nm. The epoxy resin can be observed between the fibers, for example, under an electron microscope. Since the fibers are entangled with each other with the epoxy resin therebetween to form a reinforcing structure, the fibers preferably have a fiber diameter of 5 to 500 nm, more preferably 5 to 200 nm.

Although the term “cellulose nanofibers in a pulverized state” as used herein is difficult to define precisely, it refers to, for example, cellulose fibers after fibrillation that are shorter than those before fibrillation. Although the cellulose nanofibers after fibrillation may have the same length as those before fibrillation without being pulverized, they are preferably pulverized and made shorter than those before fibrillation for reasons of dispersibility. Thus, although the cellulose nanofibers may be present in the epoxy resin simply in a fibrillated state, they are preferably present in a fibrillated and pulverized state.

The term “cellulose nanofibers in an unfibrillated state” refers to cellulose fibers clustered to a fiber diameter of more than 1 μm, which can be observed, for example, under an electron microscope.

The reinforcing material according to the present invention, which contains cellulose nanofibers obtained by fibrillating cellulose in an epoxy resin, can be directly used as a reinforcing material without the need for the process of purifying the cellulose nanofibers and serves as a suitable reinforcing material having a high affinity for a matrix resin.

The reinforcing material may contain, for example, various resins, additives, and organic and inorganic fillers. These resins, additives, and organic and inorganic fillers may be added before or after the fibrillation of cellulose.

### Cellulose

The cellulose used in the present invention may be any cellulose that can be subjected to fibrillation and/or pulverization. Examples of such celluloses include pulp; cotton; paper; regenerated cellulose fibers such as rayon, cupra, polynosic, and acetate; bacterial cellulose; and animal-derived celluloses such as those from sea squirts. The surface of these celluloses may optionally be chemically modified.

Suitable pulps include both wood pulps and non-wood pulps. Examples of wood pulps include mechanical pulps and chemical pulps, of which chemical pulps are preferred for their low lignin contents. Examples of chemical pulps include sulfide pulp, craft pulp, and alkali pulp, all of which are suitable. Examples of non-wood pulps include straw, bagasse, kenaf, bamboo, reed, paper mulberry, and flax, all of which can be used.

Cotton is a plant mainly used as clothing fibers. Raw cotton, cotton fibers, and cotton fabric can all be used.

Paper is made of fibers collected from pulp. Used paper is also suitable, including newspapers, waste milk packages, and used copy paper.

The cellulose to be pulverized may be a cellulose powder obtained by crushing cellulose and having a certain particle size distribution. Examples of such cellulose powders include KC Flock (registered trademark) from Nippon Paper Chemicals Co., Ltd., Ceolus (registered trademark) from Asahi Kasei Chemicals Corporation, and Avicel (registered trademark) from FMC Corporation.

The cellulose nanofibers used in the present invention may be modified. The cellulose nanofibers used in the present invention may be modified cellulose nanofibers obtained by fibrillating and/or pulverizing cellulose in an epoxy resin to manufacture cellulose nanofibers and then adding and reacting a modifier compound with the cellulose nanofibers in the epoxy resin.

Examples of modifier compounds include compounds capable of modifying the cellulose nanofibers by allowing functional groups such as alkyl, acyl, acylamino, cyano, alkoxy, aryl, amino, aryloxy, silyl, and carboxyl to bind chemically to the cellulose nanofibers.

The cellulose nanofibers may also be modified with modifier compounds capable of adsorbing physically onto the cellulose nanofibers, rather than binding chemically thereto. Examples of physically adsorbing compounds include surfactants. Although anionic, cationic, and nonionic surfactants may all be used, cationic surfactants are preferred.

### Epoxy Resin

The epoxy resin used in the present invention is a compound that has one or more oxirane rings, i.e., epoxy groups, per molecule and that reacts with a suitable reagent to form a three-dimensional network structure.

The epoxy resin used in the present invention is a compound having an oxirane ring, i.e., an epoxy group, per molecule and may have, for example, any structure. Examples of epoxy resins include polyfunctional epoxy resins and monofunctional epoxy resins. Examples of polyfunctional epoxy resins include bisphenol A epoxy resins, bisphenol F epoxy resins, bisphenol AD epoxy resins, bisphenol S epoxy resins, phenol novolac epoxy resins, cresol novolac epoxy resins, p-tert-butylphenol novolac epoxy resins, nonylphenol novolac epoxy resins, and t-butylcatechol epoxy resins. Examples of monofunctional epoxy resins include condensates of epihalohydrins with aliphatic alcohols such as butanol, aliphatic alcohols having 11 or 12 carbon atoms, or monohydric phenols such as phenol, p-ethylphenol, o-cresol, m-cresol, p-cresol, p-t-butylphenol, s-butylphenol, nonylphenol, and xylenol; and condensates of epihalohydrins with monofunctional carboxyl groups such as neodecanoic acid. Other examples include glycidylamines such as condensates of epihalohydrins with diaminodiphenylmethane; polyfunctional aliphatic epoxy resins such as polyglycidyl ethers of vegetable oils such as soybean oil and castor oil; polyfunctional alkylene glycol epoxy resins such as condensates of epihalohydrins with ethylene glycol, propylene glycol, 1,4-butanediol, 1,6-hexanediol, glycerol, erythritol, polyethylene glycol, polypropylene glycol, polytetramethylene ether glycol, and trimethylolpropane; and the water-based epoxy resins disclosed in Japanese Unexamined Patent Application Publication No. 2005-239928. These may be used alone or in combination.

The epoxy resin may optionally be liquefied or thinned, for example, by adding a nonreactive diluent.

### Method for Manufacturing Reinforcing Material

The cellulose may be fibrillated and/or pulverized by adding the cellulose to the epoxy resin and applying a mechanical shear force to the cellulose. Examples of means for applying a shear force include known mixers such as bead mills, ultrasonic homogenizers, extruders such as single-screw extruders and twin-screw extruders, Banbury mixers, grinders, pressure kneaders, and two-roll mills. Preferred among these are pressure kneaders, which produce a stable shear force in high-viscosity resins. These means for applying a shear force allow the cellulose nanofibers to be fibrillated to a fiber diameter of 5 to 1,000 nm and to be pulverized to a fiber length of 1 mm or less. Although fibrillation and pulverization may be independently performed to the above ranges, they are preferably simultaneously performed to the above ranges.

Although the cellulose may be added to the epoxy resin in any proportion in the present invention, the cellulose is preferably added in an amount of 10% to 90%, more preferably 30% to 70%, even more preferably 40% to 60%, of the total mass of the epoxy resin and the cellulose to achieve the desired fibrillated state and the desired pulverized state after the application of a shear force to the mixture of the epoxy resin and the cellulose. The reinforcing material can thus be manufactured in a simple manner.

### Matrix Resin

The matrix resin used in the present invention may be any resin that can be combined with reinforcing fibers, described later. The matrix resin may be a monomer, an oligomer, or a polymer, and the polymer may be a homopolymer or a copolymer. These may be used alone or in combination. For polymers, both thermoplastic resins and thermosetting resins may be used.

Thermoplastic resins are resins that are melted for molding by heating. Examples of thermoplastic resins include polyethylene resins, polypropylene resins, polystyrene resins, rubber-modified polystyrene resins, acrylonitrile-butadiene-styrene (ABS) resins, acrylonitrile-styrene (AS) resins, polymethyl methacrylate resins, acrylic resins, polyvinyl chloride resins, polyvinylidene chloride resins, polyethylene terephthalate resins, ethylene-vinyl alcohol resins, cellulose acetate resins, ionomer resins, polyacrylonitrile resins, polyamide resins, polyacetal resins, polybutylene terephthalate resins, polylactic acid resins, polyphenylene ether resins, modified polyphenylene ether resins, polycarbonate resins, polysulfone resins, polyphenylene sulfide resins, polyetherimide resins, polyethersulfone resins, polyarylate resins, thermoplastic polyimide resins, polyamide-imide resins, polyetheretherketone resins, polyketone resins, liquid crystal polyester resins, fluorocarbon resins, syndiotactic polystyrene resins, and cyclic polyolefin resins. These thermoplastic resins may be used alone or in combination.

Thermosetting resins are resins having the property of becoming substantially insoluble and infusible when cured by means such as heat, light, UV rays, radiation, and catalysts. Examples of thermosetting resins include phenolic resins, urea resins, melamine resins, benzoguanamine resins, alkyd resins, unsaturated polyester resins, vinyl ester resins, diallyl (tere)phthalate resins, epoxy resins, silicone resins, urethane resins, furan resins, ketone resins, xylene resins, and thermosetting polyimide resins. These thermosetting resins may be used alone or in combination. If the major ingredient of the resin used in the present invention is a thermoplastic resin, small amounts of thermosetting resins may be added, provided that they do not interfere with the properties of the thermoplastic resin. Conversely, if the major ingredient is a thermosetting resin, small amounts of thermoplastic resins or monomers such as acrylic and styrene may be added, provided that they do not interfere with the properties of the thermosetting resin.

The matrix resin may contain curing agents. Examples of curing agents for epoxy resins include compounds that undergo stoichiometric reactions, such as aliphatic polyamines, aromatic polyamines, dicyandiamide, polycarboxylic acids, polycarboxylic acid hydrazides, acid anhydrides, polymercaptans, and polyphenols; and compounds that act catalytically, such as imidazole, Lewis acid complexes, and onium salts. If compounds that undergo stoichiometric reactions are used, curing accelerators such as various amines, imidazole, Lewis acid complexes, onium salts, and phosphine may be added.

For vinyl ester resins and polyester resins, various organic peroxides may be added as curing agents. Examples of organic peroxides for curing at room temperature include methyl ethyl ketone peroxide and acetylacetone peroxide, which are used in combination with curing accelerators such as metal soaps, e.g., cobalt naphthenate. Examples of organic peroxides for curing by heating include t-butylperoxy isopropyl carbonate, benzoyl peroxide, bis-4-t-butylcyclohexane dicarbonate, and t-butylperoxy-2-ethyl hexanate. These compounds may be used alone or in combination.

The matrix resin may contain various conventionally known additives, provided that they do not interfere with the advantages of the present invention. Examples of such additives include hydrolysis inhibitors, colorants, flame retardants, antioxidants, polymerization initiators, polymerization inhibitors, UV absorbers, antistatic agents, lubricants, release agents, defoaming agents, leveling agents, light stabilizers (e.g., hindered amines), antioxidants, inorganic fillers, and organic fillers.

### Reinforced Matrix Resin

A reinforced matrix resin contains the reinforcing material and the matrix resin. The reinforcing material can be mixed with the matrix resin in any manner because of its high affinity for the matrix resin. The reinforced matrix resin preferably has relatively low viscosity when combined with reinforcing fibers, described later. In view of this, the cellulose nanofibers are preferably present in the reinforced matrix resin in an amount of 0.1% to 30% by mass, more preferably 0.1% to 20% by mass, even more preferably 0.1% to 10% by mass.

### Reinforcing Fibers

The reinforcing fibers used in the present invention may be any reinforcing fibers that are used in fiber-reinforced resins. Examples of such reinforcing fibers include inorganic fibers such as carbon fibers, glass fibers, aramid fibers, boron fibers, alumina fibers, and silicon carbide fibers, as well as organic fibers. Carbon fibers and glass fibers are preferred for their wide range of industrial applications. These fibers may be used alone or in combination.

The reinforcing fibers may be a collection of fibers and may be a woven fabric or a nonwoven fabric. The reinforcing fibers may also be a fiber bundle composed of fibers aligned in one direction or a sheet composed of fiber bundles. The reinforcing fibers may also be a three-dimensional collection of fibers having a certain thickness.

### Fiber-Reinforced Resin Composite

A fiber-reinforced resin composite according to the present invention contains the reinforced matrix resin and the reinforcing fibers. The reinforced matrix resin may be manufactured in advance before being combined with the reinforcing fibers. This method involves a simpler manufacturing process.

A non-limiting example of a method for manufacturing the fiber-reinforced resin composite involves the steps of fibrillating cellulose in an epoxy resin to obtain a reinforcing material in which cellulose nanofibers are present in a fibrillated state, adding the reinforcing material to a matrix resin to obtain a reinforced matrix resin, and combining the reinforced matrix resin with reinforcing fibers to obtain a fiber-reinforced resin composite. Since the cellulose is fibrillated in the epoxy resin, the resulting cellulose nanofibers are not hydrated. Therefore, a high concentration of cellulose nanofibers can be added to the matrix resin, and the reinforced matrix resin prepared in advance can be readily combined with the reinforcing fibers. Examples of processes for combining the reinforced matrix resin with the reinforcing fibers include mixing, coating, impregnation, injection, and press bonding, any of which may be selected depending on the form of the reinforcing fibers and the application of the fiber-reinforced resin composite.

For reasons of dispersibility of the cellulose nanofibers, the proportion of the reinforcing material to the matrix resin in the fiber-reinforced resin composite is preferably determined such that the cellulose nanofibers are present in an amount of 0.1% to 30% by mass, more preferably 0.1% to 20% by mass, even more preferably 0.1% to 10% by mass, based on a total of 100 parts by mass of the matrix resin and the reinforcing material.

### Other Additives

The fiber-reinforced resin composite may contain various conventionally known additives depending on the application. Examples of such additives include hydrolysis inhibitors, colorants, flame retardants, antioxidants, polymerization initiators, polymerization inhibitors, UV absorbers, antistatic agents, lubricants, release agents, defoaming agents, leveling agents, light stabilizers (e.g., hindered amines), antioxidants, inorganic fillers, and organic fillers.

The fiber-reinforced resin composite according to the present invention can be used as a molding material, a coating material, a paint material, or an adhesive.

### Molding Process

If plate-shaped products are manufactured using the fiber-reinforced resin composite according to the present invention, extrusion molding is typically used, although a flat press can also be used. Other processes include profile extrusion molding, blow molding, compression molding, vacuum molding, and injection molding. If film-shaped products are manufactured, melt extrusion and solution casting may be used. Examples of melt molding processes, if used, include inflation film molding, casting, extrusion lamination molding, calendering, sheet molding, fiber molding, blow molding, injection molding, rotational molding, and coating. For actinic-radiation-curable resins, molded products may be manufactured by various curing processes using actinic radiation. If the major ingredient of the matrix resin is a thermosetting resin, a pre-preg prepared from the molding material may be molded by heating and pressing using a press or autoclave. Other processes include resin transfer molding (RTM), vacuum-assisted resin transfer molding (VaRTM), lamination molding, and hand lay-up molding.

### Application

The fiber-reinforced resin composite according to the present invention is suitable for use in various applications. Examples of such applications include industrial mechanical components (e.g., electromagnetic device housings, roll materials, transfer arms, and medical device components), general mechanical components, automotive, railroad, and vehicle components (e.g., outer panels, chassis, aerodynamic components, and seats), ship components (e.g., hulls and seats), aviation-related components (e.g., fuselages, wings, empennages, flight control surfaces, fairings, cowlings, doors, seats, and interior materials), spacecraft and satellite components (e.g., motor cases, wings, structures, and antennas), electrical and electronic components (e.g., personal computer housings, cellular phone housings, OA equipment, AV equipment, telephones, facsimiles, household electrical appliances, and toys), building and construction materials (e.g., alternative reinforcing bars, truss structures, and suspension bridge cables), housewares, sports and leisure products (e.g., golf club shafts, fishing rods, and rackets for tennis and badminton), and housing components for wind power generation. Other suitable applications include containers and packaging components such as high-pressure containers to be filled with gases such as hydrogen gas for fuel cells.

### EXAMPLES

Embodiments of the present invention are further illustrated below. Parts and percentages are by mass unless otherwise specified.

### Example 1

### Manufacture of Reinforcing Material 1

Provided were 600 parts by mass of Epiclon (registered trademark) 850S liquid epoxy resin available from DIC Corporation and 400 parts by mass of KC Flock (registered trademark) W-50GK cellulose powder (fiber diameter: about 20 to 30 μm, fiber length: about 200 to 400 μm) available from Nippon Paper Chemicals Co., Ltd. The cellulose was fibrillated by mixing under pressure using a pressure kneader (DS1-5GHH-H) available from Moriyama Seisakusho Co., Ltd. at 60 rpm for 600 minutes to obtain Reinforcing Material 1 as a masterbatch.

Examination of Reinforcing Material 1 under a scanning electron microscope showed that the cellulose fibers were fibrillated to fiber diameters of about 100 to 300 nm. The average fiber diameter of randomly selected 20 cellulose fibers was about 180 nm. The examination also showed that the cellulose fibers were shorter than the original fibers. These results for Reinforcing Material 1 demonstrate that the cellulose nanofibers were uniformly dispersed in the epoxy resin in a well-fibrillated and pulverized state.

### Manufacture of Reinforced Matrix Resin 1

To 100 parts by mass of Epiclon (registered trademark) 850S liquid epoxy resin available from DIC Corporation, serving as a matrix resin, was added 1 part by mass of Reinforcing Material 1. The mixture was stirred at 12,000 rpm for 5 minutes using a Labolution (registered trademark) mixing system available from Primix Corporation equipped with a Neo-Mixer (registered trademark) Type 4-2.5 stirring blade available from Primix Corporation. To the mixture was added 32 parts by mass of Laromin (registered trademark) C260 available from BASF, serving as a curing agent, followed by stirring to obtain Reinforced Matrix Resin 1. Reinforced Matrix Resin 1 contained 0.3% by mass cellulose nanofibers.

Examination of the cellulose nanofibers in Reinforced Matrix Resin 1 under a scanning electron microscope showed that, as in Reinforcing Material 1, the cellulose fibers were fibrillated to fiber diameters of about 100 to 300 nm. The average fiber diameter of randomly selected 20 cellulose fibers was about 180 nm. The examination also showed that the cellulose fibers were shorter than the original fibers. These results for Reinforced Matrix Resin 1 demonstrate that the cellulose nanofibers were uniformly dispersed in the epoxy resin in a well-fibrillated and pulverized state.

### Manufacture of Fiber-Reinforced Resin Composite 1

After the degassing of Reinforced Matrix Resin 1, a Pyrofil (registered trademark) carbon fiber fabric (TR-3110-MS, 230 mm×230 mm) available from Mitsubishi Rayon Co., Ltd., serving as reinforcing fibers, was impregnated with Reinforced Matrix Resin 1 in a mold (230 mm×230 mm×1.6 mm) heated to 50° C. This procedure was repeated eight times to laminate eight carbon fiber fabrics. The mold was closed, and the laminate was heated at 80° C. and pressed under a surface pressure of 1 MPa for 60 minutes and was then heated at 150° C. and pressed under a surface pressure of 1 MPa for 3 hours to obtain Fiber-Reinforced Resin Composite 1. Fiber-Reinforced Resin Composite 1 had a thickness of 1.6 mm.

### Bending Strength Test

Fiber-Reinforced Resin Composite 1 was subjected to a bending strength test according to JIS K 7074. A specimen having a width of 15 mm and a length of 100 mm was cut from Fiber-Reinforced Resin Composite 1 along the weave of the carbon fabric using a diamond cutter. The specimen was tested five times by a three-point bending test using a universal testing machine available from Instron Corporation at a span of 80 mm and a test speed of 5 mm/min in an atmosphere at a room temperature of 23° C. and a humidity of 50%. The bending strength was determined as the average maximum stress. Molded Product 1 had a bending strength of 850 MPa.

### Example 2

### Manufacture of Fiber-Reinforced Resin Composite 2

Fiber-Reinforced Resin Composite 2 was obtained as in Example 1 except that the amount of Reinforcing Material 1 was 1.67 parts by mass, rather than 1 part by mass. Fiber-Reinforced Resin Composite 2 had a bending strength of 870 MPa.

### Example 3

### Manufacture of Fiber-Reinforced Resin Composite 3

Fiber-Reinforced Resin Composite 3 was obtained as in Example 1 except that the amount of Reinforcing Material 1 was 3.38 parts by mass, rather than 1 part by mass. Fiber-Reinforced Resin Composite 3 had a bending strength of 890 MPa.

### Example 4

### Manufacture of Fiber-Reinforced Resin Composite 4

Fiber-Reinforced Resin Composite 4 was obtained as in Example 1 except that the amount of Reinforcing Material 1 was 10.7 parts by mass, rather than 1 part by mass. Fiber-Reinforced Resin Composite 4 had a bending strength of 960 MPa.

### Example 5

### Manufacture of Reinforced Matrix Resin 5

Reinforced Matrix Resin 5 was obtained as in Example 1 except that the amount of Reinforcing Material 1 was 1.67 parts by mass. Reinforced Matrix Resin 5 contained 0.5% by mass cellulose nanofibers.

Examination of the cellulose nanofibers in Reinforced Matrix Resin 5 under a scanning electron microscope showed that, as in Reinforcing Material 1, the cellulose fibers were fibrillated to fiber diameters of about 100 to 300 nm. The average fiber diameter of randomly selected 20 cellulose fibers was about 180 nm. The examination also showed that the cellulose fibers were shorter than the original fibers. These results for Reinforced Matrix Resin 1 demonstrate that the cellulose nanofibers were in a well-fibrillated and pulverized state.

### Manufacture of Fiber-Reinforced Composite 5

After the degassing of Reinforced Matrix Resin 5, a unidirectional carbon fiber fabric with a filament count of 48K (4,800), a carbon fiber diameter of 6 μm, and a width of 40 mm (BHH-48K40SW, cut to a length of 230 mm in the fiber direction, product width: 40 mm) available from Sakai Ovex Co., Ltd., serving as reinforcing fibers, was impregnated with Reinforced Matrix Resin 5 in a mold (230 mm×40 mm×2 mm) heated to 50° C. This procedure was repeated 24 times to laminate 24 carbon fiber fabrics. The mold was closed, and the laminate was heated at 80° C. and pressed under a surface pressure of 1 MPa for 60 minutes and was then heated at 150° C. and pressed under a surface pressure of 1 MPa for 3 hours to obtain Fiber-Reinforced Resin Composite 5, which was reinforced with carbon fibers only in one direction. Fiber-Reinforced Resin Composite 5 had a thickness of 2 mm.

### Bending Strength Test

Fiber-Reinforced Resin Composite 5 was cut to a length of 100 mm in the carbon fiber direction by the same procedure as in the bending strength test in Example 1 and was subjected to a bending strength test in the direction parallel to the carbon fibers. Fiber-Reinforced Resin Composite 5 had a bending strength of 950 MPa.

### Comparative Example 1

### Manufacture of Comparative Fiber-Reinforced Composite 1

Comparative Fiber-Reinforced Composite 1 was obtained as in Example 1 except that Reinforcing Material 1 was not added (i.e., the cellulose nanofiber content was 0%). Comparative Fiber-Reinforced Composite 1 had a bending strength of 740 MPa.

### Comparative Example 2

### Manufacture of Comparative Reinforced Matrix Resin 2

To 4 parts by mass of ethanol was added 4 parts by mass of Celish (registered trademark) KY-100G (fiber diameter: about 0.01 to 0.1 μm) available from Daicel Finechem Ltd., serving as cellulose nanofibers, followed by stirring and suction filtration. The resulting wet cake of the cellulose nanofibers was adjusted to a solid content of 1% by adding ethanol, and the mixture was sonicated. To 100 parts by mass of Epiclon (registered trademark) 850S liquid epoxy resin available from DIC Corporation was added 40 parts by mass of the ethanol slurry of the cellulose nanofibers (solid content: 1%). The mixture was stirred at 12,000 rpm for 5 minutes using a Labolution (registered trademark) mixing system available from Primix Corporation equipped with a Neo-Mixer (registered commercial law) Type 4-2.5 stirring blade available from Primix Corporation. The thus-processed resin was treated in a vacuum drying oven at 90° C. until no volatile component remained. To the resin was added 32 parts by mass of Laromin (registered trademark) C260 available from BASF, serving as a curing agent, followed by stirring to obtain Comparative Reinforced Matrix Resin 2, which contained 0.3% cellulose nanofibers.

Examination of the cellulose nanofibers in Comparative Reinforced Matrix Resin 2 under a scanning electron microscope showed that there were numerous aggregates with fiber diameters of 1 μm or more.

### Manufacture of Comparative Fiber-Reinforced Resin Composite 2

After the degassing of Comparative Reinforced Matrix Resin 2, a Pyrofil (registered trademark) carbon fiber fabric (TR-3110-MS, 230 mm×230 mm) available from Mitsubishi Rayon Co., Ltd., serving as reinforcing fibers, was impregnated with Comparative Reinforced Matrix Resin 2 in a mold (230 mm×230 mm×1.6 mm) heated to 50° C. This procedure was repeated eight times to laminate eight carbon fiber fabrics. The mold was closed, and the laminate was heated at 80° C. and pressed under a surface pressure of 1 MPa for 60 minutes and was then heated at 150° C. and pressed under a surface pressure of 1 MPa for 3 hours to obtain Comparative Fiber-Reinforced Resin Composite 2. Comparative Fiber-Reinforced Resin Composite 2 had a thickness of 1.6 mm. Comparative Fiber-Reinforced Resin Composite 2 had a bending strength of 790 MPa.

### Comparative Example 3

### Manufacture of Comparative Fiber-Reinforced Resin Composite 3

Comparative Reinforced Matrix Resin 3 was obtained as in Comparative Example 2 except that the amount of the ethanol slurry of the cellulose nanofibers (solid content: 1%) was 66 parts, rather than 40 parts by mass. Comparative Reinforced Matrix Resin 3 was a gel-like resin containing 0.5% cellulose nanofibers. Comparative Fiber-Reinforced Resin Composite 3 was not available since an attempt to impregnate carbon fibers with Comparative Reinforced Matrix Resin 3 as in Comparative Example 2 was unsuccessful.

### Example 6

### Manufacture of Reinforced Matrix Resin 6

To 100 parts by mass of Diclite (registered trademark) UE-3505 liquid vinyl ester resin available from DIC Corporation, serving as a matrix resin, was added 2.59 parts by mass of Reinforcing Material 1. The mixture was stirred at 8,000 rpm for 5 minutes using a Labolution (registered trademark) mixing system available from Primix Corporation equipped with a Neo-Mixer (registered trademark) Type 4-2.5 stirring blade available from Primix Corporation. To the mixture was added 1 part by mass of Kayacarbon (registered trademark) AIC-75 available from Kayaku Akzo Corporation, serving as a curing agent, followed by stirring to obtain Reinforced Matrix Resin 6. Reinforced Matrix Resin 6 contained 1% by mass cellulose nanofibers.

Examination of the cellulose nanofibers in Reinforced Matrix Resin 6 under a scanning electron microscope showed that, as in Reinforcing Material 1, the cellulose fibers were fibrillated to fiber diameters of about 100 to 300 nm. The average fiber diameter of randomly selected 20 cellulose fibers was about 180 nm. These results for Reinforced Matrix Resin 6 demonstrate that the cellulose nanofibers were uniformly dispersed in the epoxy resin in a well-fibrillated and pulverized state.

### Manufacture of Fiber-Reinforced Resin Composite 6

After the degassing of Reinforced Matrix Resin 6, a Torayca (registered trademark) carbon fiber fabric (C06644B, 230 mm×230 mm) available from Toray Industries, Inc., serving as reinforcing fibers, was impregnated with Reinforced Matrix Resin 6 in a mold (230 mm×230 mm×2 mm) heated to 30° C. This procedure was repeated five times to laminate five carbon fiber fabrics. The mold was closed, and the laminate was heated at 125° C. and pressed under a surface pressure of 5 MPa for 15 minutes to obtain Fiber-Reinforced Resin Composite 6. Fiber-Reinforced Resin Composite 6 had a thickness of 2.0 mm. Fiber-Reinforced Resin Composite 6 had a bending strength of 580 MPa.

### Example 7

### Manufacture of Fiber-Reinforced Resin Composite 7

Fiber-Reinforced Resin Composite 7 was obtained as in Example 6 except that the amount of Reinforcing Material 1 was 14.43 parts by mass, rather than 2.59 parts by mass. Reinforced Matrix Resin 7 contained 5% by mass cellulose nanofibers. Fiber-Reinforced Resin Composite 7 had a bending strength of 630 MPa.

### Example 8

### Manufacture of Fiber-Reinforced Resin Composite 8

Fiber-Reinforced Resin Composite 8 was obtained as in Example 6 except that the amount of Reinforcing Material 1 was 33.67 parts by mass, rather than 2.59 parts by mass. Reinforced Matrix Resin 8 contained 10% by mass cellulose nanofibers. Fiber-Reinforced Resin Composite 8 had a bending strength of 670 MPa.

### Comparative Example 4

### Manufacture of Comparative Fiber-Reinforced Resin Composite 4

Comparative Fiber-Reinforced Resin Composite 4 was obtained as in Example 6 except that Reinforcing Material 1 was not added (i.e., the cellulose nanofiber content was 0%). Comparative Fiber-Reinforced Resin Composite 4 had a bending strength of 540 MPa.

### Comparative Example 5

### Manufacture of Comparative Fiber-Reinforced Resin Composite 5

In a vacuum drying oven at 90° C., 102 parts of the ethanol slurry of the cellulose nanofibers (solid content: 1%) in Comparative Example 2 was dried until there was no weight change. The dried cellulose nanofibers were added to 100 parts by mass of Diclite (registered trademark) UE-3505 vinyl ester resin available from DIC Corporation, serving as a matrix resin. The mixture was stirred at 8,000 rpm for 5 minutes using a Labolution (registered trademark) mixing system available from Primix Corporation. To the mixture was added 1 part by mass of Kayacarbon (registered trademark) AIC-75 available from Kayaku Akzo Corporation, serving as a curing agent, followed by stirring. The resulting resin was not moldable since the cellulose nanofibers were poorly dispersed in the resin. Aggregates of cellulose nanofibers large enough to be visually observed were also found in the resin.

### Example 9

### Manufacture of Reinforced Matrix Resin 9

To 100 parts by mass of Diclite (registered trademark) UE-3505 liquid vinyl ester resin available from DIC Corporation, serving as a matrix resin, was added 2.59 parts by mass of Reinforcing Material 1. The mixture was stirred at 8,000 rpm for 5 minutes using a Labolution (registered trademark) mixing system available from Primix Corporation equipped with a Neo-Mixer (registered trademark) Type 4-2.5 stirring blade available from Primix Corporation. To the mixture was added 1 part by mass of Kayacarbon (registered trademark) AIC-75 available from Kayaku Akzo Corporation, serving as a curing agent, followed by stirring to obtain Reinforced Matrix Resin 9. Reinforced Matrix Resin 9 contained 1% by mass cellulose nanofibers.

### Manufacture of Fiber-Reinforced Resin Composite 9

After the degassing of Reinforced Matrix Resin 9, a glass fiber fabric (MC450A, 230 mm×230 mm) available from Nitto Boseki Co., Ltd., serving as reinforcing fibers, was impregnated with Reinforced Matrix Resin 9 in a mold (230 mm×230 mm×1.6 mm) heated to 30° C. This procedure was repeated twice to laminate two glass fiber fabrics. The mold was closed, and the laminate was heated at 125° C. and pressed under a surface pressure of 1 MPa for 15 minutes to obtain Fiber-Reinforced Resin Composite 9. Fiber-Reinforced Resin Composite 9 had a thickness of 1.6 mm. Fiber-Reinforced Resin Composite 9 had a bending strength of 240 MPa.

### Comparative Example 6

### Manufacture of Comparative Fiber-Reinforced Resin Composite 6

Comparative Fiber-Reinforced Resin Composite 6 was obtained as in Example 9 except that Reinforcing Material 1 was not added. Comparative Fiber-Reinforced Resin Composite 6 had a bending strength of 208 MPa.

### Comparative Example 7

### Manufacture of Comparative Fiber-Reinforced Resin Composite 7

In a vacuum drying oven at 90° C., 102 parts of the ethanol slurry of the cellulose nanofibers (solid content: 1%) in Comparative Example 2 was dried until there was no weight change. The dried cellulose nanofibers were added to 100 parts by mass of Diclite (registered trademark) UE-3505 vinyl ester resin available from DIC Corporation. The mixture was stirred at 8,000 rpm for 5 minutes using a Labolution (registered trademark) mixing system available from Primix Corporation. To the mixture was added 1 part by mass of Kayacarbon (registered trademark) AIC-75 available from Kayaku Akzo Corporation, serving as a curing agent, followed by stirring. The resulting resin was not moldable since the cellulose nanofibers were poorly dispersed in the resin. Aggregates of cellulose nanofibers large enough to be visually observed were also found in the resin.

### Comparative Example 8

### Manufacture of Comparative Fiber-Reinforced Resin Composite 8

As cellulose nanofibers, 10.2 parts by weight of Celish (registered trademark) KY-100G (fiber diameter: about 0.01 to 0.1 μm) available from Daicel Finechem Ltd. was diluted to 10 times with distilled water and was frozen in dry ice. The frozen cellulose nanofibers were dried in a freeze dryer until there was no weight change. To 100 parts by mass of Diclite (registered trademark) UE-3505 vinyl ester resin available from DIC Corporation was added 1.02 parts by weight of the resulting solid. The mixture was stirred at 8,000 rpm for 5 minutes using a Labolution (registered trademark) mixing system available from Primix Corporation. To the mixture was added 1 part by mass of Kayacarbon (registered trademark) AIC-75 available from Kayaku Akzo Corporation, serving as a curing agent, followed by stirring. During stirring, the viscosity rose rapidly, and the cellulose nanofibers were no longer dispersed. The resulting undispersed resin was not moldable because of its poor permeability into glass fibers. Aggregates of cellulose nanofibers large enough to be visually observed were also found in the resin.

Tables 1 to 3 summarize the results for Examples 1 to 9 and Comparative Examples 1 to 8.

TABLE 1

| Carbon-fiber-reinforced resin | Cellulose nanofiber | Bending strength |
|---|---|---|
| composite (epoxy resin) | content (% by weight) | (MPa) |
| Example 1 | 0.3% | 850 |
| Example 2 | 0.5% | 870 |
| Example 3 | 1.0% | 890 |
| Example 4 | 3.0% | 960 |
| Example 5 | 0.5% | 950 |
| Comparative Example 1 | 0% | 740 |
| Comparative Example 2 | 0.3% | 790 |
| Comparative Example 3 | 0.5% | Not moldable |

TABLE 2

| Carbon-fiber-reinforced resin | Cellulose nanofiber | Bending strength |
|---|---|---|
| composite (vinyl ester resin) | content (% by weight) | (MPa) |
| Example 6 | 1.0% | 580 |
| Example 7 | 5.0% | 630 |
| Example 8 | 10.0% | 670 |
| Comparative Example 4 | 0% | 540 |
| Comparative Example 5 | 1.0% | Not moldable |

TABLE 3

| Glass-fiber-reinforced resin | Cellulose nanofiber content | Bending |
|---|---|---|
| composite | (% by weight) | strength (MPa) |
| Example 9 | 1.0% | 240 |
| Comparative Example 6 | 0% | 208 |
| Comparative Example 7 | 1.0% | Not moldable |
| Comparative Example 8 | 1.0% | Not moldable |

### INDUSTRIAL APPLICABILITY

The reinforcing material according to the present invention can be used in a reinforced matrix resin for a fiber-reinforced resin to combine a high concentration of cellulose nanofibers with the fiber-reinforced resin. The fiber-reinforced resin composite according to the present invention has high strength and is therefore suitable for use in applications such as industrial mechanical components (e.g., electromagnetic device housings, roll materials, transfer arms, and medical device components), general mechanical components, automotive, railroad, and vehicle components (e.g., outer panels, chassis, aerodynamic components, and seats), ship components (e.g., hulls and seats), aviation-related components (e.g., fuselages, wings, empennages, flight control surfaces, fairings, cowlings, doors, seats, and interior materials), spacecraft and satellite components (e.g., motor cases, wings, structures, and antennas), electrical and electronic components (e.g., personal computer housings, cellular phone housings, OA equipment, AV equipment, telephones, facsimiles, household electrical appliances, and toys), building and construction materials (e.g., alternative reinforcing bars, truss structures, and suspension bridge cables), housewares, sports and leisure products (e.g., golf club shafts, fishing rods, and rackets for tennis and badminton), housing components for wind power generation, and containers and packaging components such as high-pressure containers to be filled with gases such as hydrogen gas for fuel cells.

1. A reinforcing material comprising an epoxy resin and cellulose nanofibers present therein in a fibrillated state.

2. The reinforcing material according to claim 1, wherein the cellulose nanofibers are obtained by fibrillating cellulose in the epoxy resin.

3. The reinforcing material according to claim 1, wherein the cellulose nanofibers have a fiber diameter of 5 to 1,000 nm.

4. A reinforced matrix resin comprising the reinforcing material according to claim 1 and a matrix resin.

5. A fiber-reinforced resin composite comprising the reinforced matrix resin according to claim 4 and reinforcing fibers.

6. A method for manufacturing a reinforcing material, comprising adding cellulose to an epoxy resin and applying a mechanical shear force to the cellulose to form nanofibers.

7. The method for manufacturing a reinforcing material according to claim 6, wherein the cellulose is present in an amount of 10% to 90% of the total mass of the epoxy resin and the cellulose.

8. The reinforcing material according to claim 2, wherein the cellulose nanofibers have a fiber diameter of 5 to 1,000 nm.

9. A reinforced matrix resin comprising the reinforcing material according to claim 2 and a matrix resin.

10. A reinforced matrix resin comprising the reinforcing material according to claim 3 and a matrix resin.

11. A reinforced matrix resin comprising the reinforcing material according to claim 8 and a matrix resin.

12. A fiber-reinforced resin composite comprising the reinforced matrix resin according to claim 9 and reinforcing fibers.

13. A fiber-reinforced resin composite comprising the reinforced matrix resin according to claim 10 and reinforcing fibers.

14. A fiber-reinforced resin composite comprising the reinforced matrix resin according to claim 11 and reinforcing fibers.
